(19) United States
(12) Patent Application Publication
(10) Pub. No.: US 2007/0153523 A1
(43) Pub. Date: Jul. 5, 2007

(54) FLOATING WATER ACTIVATED LIGHT

(75) Inventors: David C. Thornhill, Wichita, KS (US); Kevin J. Tarter, Wichita, KS (US); Darin M. Webb, Wichita, KS (US)

Correspondence Address: LEYDIG, VOIT & MAYER, LTD.;(SEATTLE OFFICE), TWO PRUDENTIAL PLAZA, SUITE 4900, CHICAGO, IL, 60601-6731, US

(73) Assignee: The Coleman Company, Inc., Wichita, KS (US)

(21) Appl. No.: 11/379,532

(22) Filed: Apr. 20, 2006

Related U.S. Application Data
(63) Continuation-in-part of application No. 11/325,911, filed on Jan. 4, 2006.

(51) Int. Cl. F21V 23/04

(52) U.S. Cl. 362/276

(57) ABSTRACT

A flashlight that includes contacts that close a circuit when the flashlight is in water. The closed circuit provides a connection between batteries and a lamp, lighting the lamp. The flashlight is sealed so that it floats when dropped in the water.

### REFERENCE TO RELATED APPLICATION

This application is a continuation in part of U.S. application Ser. No. 11/325,911, filed Jan. 4, 2006, and incorporated herein by reference.

### TECHNICAL FIELD OF THE INVENTION

The present invention is directed to lights, and more particularly to flashlights.

### BACKGROUND OF THE INVENTION

In general, a flashlight is a portable electric light, such as a luminaire configured to be held by a user. Flashlights are useful for a variety of different applications, including use for light in the outdoors, backup lighting in a power outage, or as a source of light to find an object in a dark location.

Other portable electric lights, in the form of luminaires, are available for use by individuals. As examples, electric lanterns, key fobs, and headlamps are popular lights that may be used when in the outdoors.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment, a floating light is provided. The light includes contacts that close a circuit when the light is in water. The closed circuit provides a connection between batteries or another power source and a lamp, lighting the lamp. The light may be sealed so that it floats when dropped in the water and/or may include buoyant material.

Other features of the invention will become apparent from the following detailed description when taken in conjunction with the drawings, in which:

### BRIEF DESCRIPTION OF THE DRAWINGS

FIG. 1 shows a side perspective view of a flashlight in accordance with an embodiment, with the flashlight shown floating in water;

FIG. 2 shows a cutaway view of the flashlight of FIG. 1;

FIG. 3 shows a circuit that may be used for the flashlight of FIG. 1;

FIG. 4 shows a side perspective view of a key fob in accordance with an embodiment, with the key fob shown floating in water;

FIG. 5 shows a side perspective view of a lantern in accordance with an embodiment, with the lantern shown floating in water;

FIG. 6 shows a side perspective view of an alternate embodiment of a flashlight, with the flashlight shown floating in water; and

FIG. 7 is an exploded side perspective view of the flashlight of FIG. 6, shown as being installed in a charging cradle.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

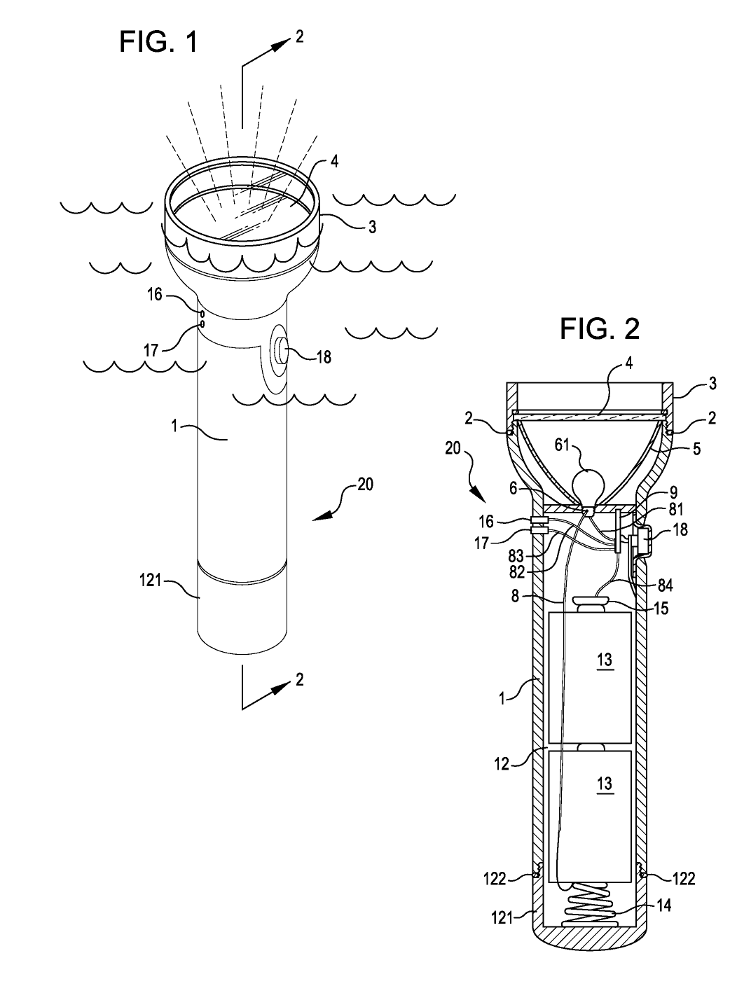

Referring now to the drawings, in which like reference numerals represent like parts throughout the several views, FIG. 1 shows a flashlight 20 in accordance with an embodiment of the invention. The flashlight 20 includes a housing 1 having a waterproof seal 2 (FIG. 2), such as an O-ring, at an upward portion. The O-ring 2 forms a seal between the housing 1 and a lamp cover 3. A lens 4 extends across the lamp cover 3, and a reflector 5 is mounted behind the lens and within the lamp cover. A bulb 61 having a bulb base 6 is mounted in the reflector 5. Although a bulb 61 is shown, the flashlight may include any form of lamp, including a light emitting diode (LED), an incandescent lamp, a fluorescent lamp, or other lights.

The flashlight 20 includes batteries 13 mounted in a battery box 12 defined by an interior of the housing 1. The housing 1 includes a bottom cap 121 for providing access to the interior of the battery box 12 to replace the batteries 13. The bottom cap 121 includes an O-ring 122 or another seal to form a watertight connection between the bottom cap 121 and the housing 1. As an alternate to batteries 13, a rechargeable battery or batteries may be used within the flashlight 20.

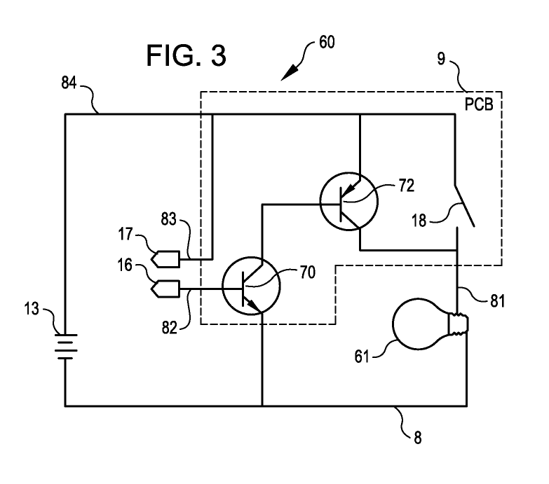

The battery box 12 includes a negative spring 14 and a positive contact 15 for contacting the negative and positive terminals of the batteries 13, respectively. A wire or cable 8 (FIG. 3) extends from the negative spring 14 to a first terminal of the bulb 61. This wire or cable, and the other wires or cables described herein, may alternatively be metal conductive contact plates or other suitable conductive connections. An additional wire 81 extends from a second terminal of the bulb 61 to a printed circuit board 9. A third wire 82 extends from the printed circuit board 9 to a first current conductor 16 that extends outside of the housing 1. A fourth wire 83 extends from the printed circuit board 9 to a second current conductor 17, which also extends outside the housing 1. A fifth wire 84 extends between the positive contact 15 and the printed circuit board 9. A manual switch 18 is provided and is connected to the printed circuit board 9. The switch includes a watertight seal in a manner known in the art.

In the embodiment shown, the flashlight 20 floats. That is, the flashlight 20 stays at a top surface of a body of water, even if only a slight portion or none of the flashlight extends above a surface of the water. The floatation provided may be sufficient only to make the flashlight buoyant, or may make a portion of the flashlight extend out of the water. To this end, the flashlight 20 is preferably sized so that the air pocket formed within the flashlight, for example behind the reflector 5, is sufficient to support the flashlight 20 along with the batteries 13, when the flashlight 20 is accidentally dropped in water. For the flashlight 20 shown in the drawings, a larger head portion is provided for this function, although air pockets may be formed at any location so as to provide this function. The size of an air pocket needed to float a flashlight may be determined empirically or by experimentation. In addition, the flashlight may be floatable in other ways, for example by the addition of Styrofoam or other buoyant materials.

In the embodiment shown in FIG. 1, the air pocket is positioned so that the flashlight 20 floats with the light side up in the water. A flashlight may alternatively be configured to float on its side or upside down.

FIG. 1 shows the exterior of the flashlight 20, and is helpful in showing that the first current conductor 16 and the second current conductor 17 are exposed on the exterior of the flashlight. These current conductors 16, 17 are positioned so that they are in contact with water when the flashlight 20 is floating, regardless of the orientation of the flashlight. In the embodiment shown in the drawings, as can be seen in FIG. 2, the flashlight is mostly submerged when floating at a surface of the water. Because the flashlight 20 is only slightly buoyant, the head of the flashlight sticks only slightly above the surface of the water. The current conductors 16, 17 are positioned at a juncture of the head of the flashlight 20 and the housing 1, and thus are positioned below the water.

Although the head of the flashlight 20 is shown at the surface of the water, a flashlight may be configured in a different manner so that a different portion is presented at the surface. As an example, a flashlight may float on its side or upside down.

FIG. 3 shows a circuit 60 that may be used with the flashlight 20 in accordance with an embodiment. As can be seen, the manual switch 18 may be used to close the circuit with the batteries 13 to turn on the bulb 61. Alternatively, an electrical connection may be provided between the first and second current conductors 16, 17. This connection may be provided, for example, when the flashlight 20 is dropped in water. Water acts as a conductor between the two current conductors 16, 17, and thus a signal is supplied to a transistor 70. This transistor in turn provides a signal to a second transistor 72, which closes the circuit between the batteries 13 and the bulb 61, turning on the bulb.

As can be understood, the flashlight 20 of the present invention is very useful when dropped in water. Not only does the flashlight 20 float, but, if the flashlight 20 is not already turned on, the bulb 61 turns on as a result of water arcing across the contacts 16, 17. Thus, the flashlight is easy to recover after being dropped in the water.

Although the flashlight 20 is of conventional form, embodiments of the invention may be used on other flashlight designs. In addition, the concepts of the present invention may be applied to any lighting appliance, including an electric lantern or a key fob.

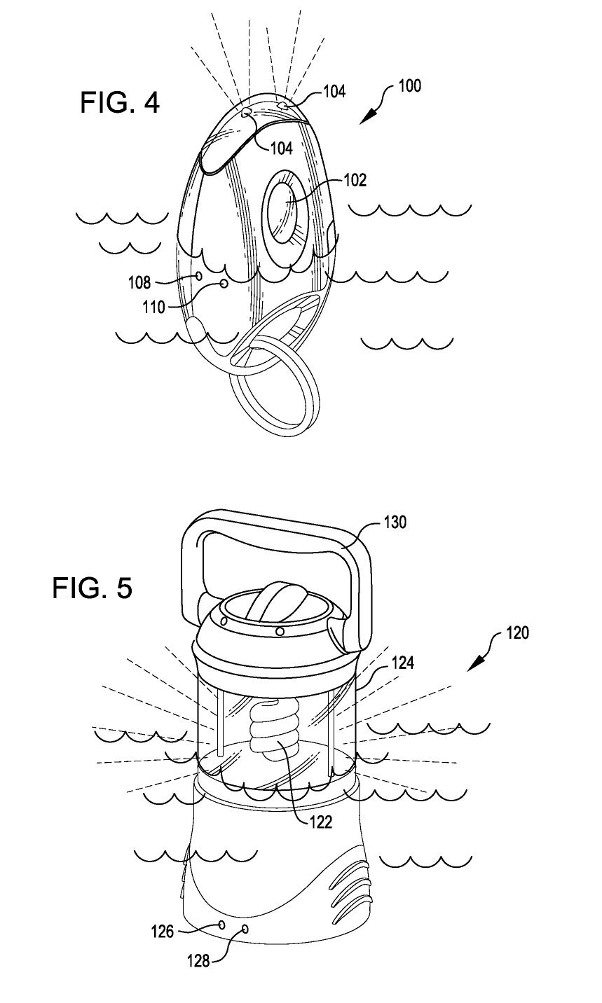

For example, a key fob 100 is shown in FIG. 4. The key fob 100 includes a switch 102 and a pair of LED lamps 104 mounted behind a clear lens 106. For the embodiment shown in the drawings, the key fob 100 includes a housing having watertight seals and is of sufficient size to include an air pocket for flotation of the key fob. As with the flashlight 20, the key fob 100 includes current conductors 108, 110 that are similar to the current conductors 16, 17. In addition, the key fob includes a circuit such as the circuit 60 or a circuit that is capable of performing a similar function.

As another example, a lantern 120 is shown in FIG. 5. The lantern 120 includes a fluorescent bulb 122 mounted within a globe 124.

For the embodiment shown in the drawings, the lantern 120 includes airtight seals and has sufficient interior space to include an air pocket that is suitable for floating of the lantern. The lantern includes current conductors 126, 128 that are similar to the current conductors 16, 17, and also includes a circuit that is similar to, or performs the same function as, the circuit 60.

For the embodiment shown in the drawings, the lantern 120 is configured so that it floats in an upright manner when dropped in the water. If desired, a portion of the globe 124 may be exposed above the surface of the water, or the globe may be completely submersed in the water. A handle 130 is provided at the top of the lantern 120, and may extend out of the water once the lantern is dropped into the water.

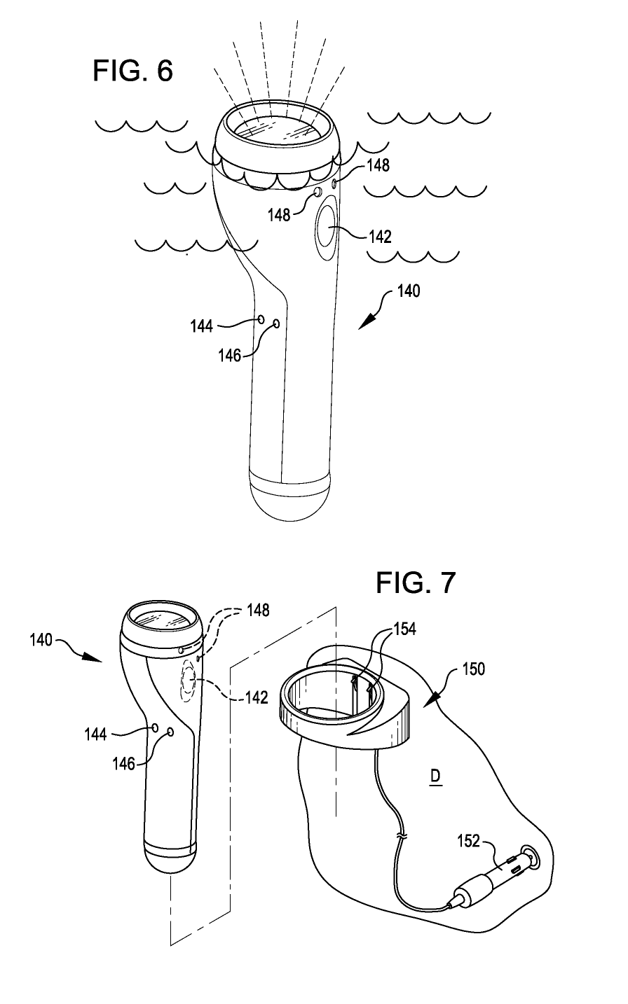

FIG. 6 shows an alternate embodiment of the flashlight 140. The flashlight 140 includes a switch 142 and current conductors 144, 146 that are similar to the current conductors 16, 17. In addition, the flashlight 140 includes contacts 148. The contacts 148 are positioned so that they may engage posts 154 on the inside of a charging cradle 150 (FIG. 7).

In accordance with an embodiment, the charging cradle 150 is designed to be mounted in a vehicle, including automobiles, boats, and recreational vehicles. The cradle 150 may, for example, include an adhesive strip for adhering to a dashboard, or may be configured to fit into a cup holder on a dashboard. A cigarette lighter adapter 152 is provided for providing power to the charging cradle 150. If desired, the charging cradle 150 may be directly attached to the cigarette lighter adapter 152. In an alternate embodiment shown in the drawings, a cord is provided between the cigarette lighter adapter 152 and the charging cradle 150.

When the flashlight 140 is placed inside the charging cradle 150, the contacts 148 align with the post 154, and rechargeable batteries (not shown) within the flashlight are charged. In addition, the flashlight 140 provides the floating and water activated functions described above.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A luminaire, comprising:
a watertight housing;
a power supply mounted in the housing;
a lamp mounted to the housing;
water contacts on the housing;
a circuit configured to turn on the lamp when the contacts come in contact with water; and
wherein the watertight housing is sized and shaped so that the luminaire floats on water.

2. The luminaire of claim 1, wherein the power supply is one or more batteries.

3. The luminaire of claim 1, wherein the luminaire is a lantern.

4. The luminaire of claim 1, wherein the lamp comprises a member of the set of a light emitting diode, an incandescent lamp, and a fluorescent lamp.

5. The luminaire of claim 1, wherein the luminaire is a key fob.

6. The luminaire of claim 1, wherein the luminaire is a flashlight.

7. A luminaire, comprising:
a power supply;
a circuit connected to the power supply;
a lamp connected to the circuit;
water contacts connected to the circuit, the circuit being configured to provide power to and turn on the lamp when the contacts come in contact with water; and
means for floating the luminaire.

8. The luminaire of claim 7, wherein the power supply is one or more batteries.

9. The luminaire of claim 7, wherein said means for floating comprises a watertight body sufficiently large so that the luminaire floats.

10. The luminaire of claim 7, wherein the lamp comprises a member of the set of a light emitting diode, an incandescent lamp, and a fluorescent lamp.

11. The luminaire of claim 7, wherein said means for floating comprises buoyant material.

12. The luminaire of claim 7, wherein the luminaire is a lantern.

13. The luminaire of claim 7, wherein the luminaire is a key fob.

14. The luminaire of claim 7, wherein the luminaire is a flashlight.

15. A flashlight and charger combination, comprising:
a flashlight having first contacts thereon; and
a charger for mounting in a vehicle, the charger including:
a cigarette lighter adapter;
a mount for connecting the charger to the inside of the vehicle; and
second contacts for engaging the first contacts when the flashlight is connected to the charger.

16. The combination of claim 15, wherein the mount connects the charger to a dashboard of the vehicle.

17. The combination of claim 16, wherein the mount adheres the charger to the dashboard.

18. A charger for the combination of claim 15.
